(19) United States
(12) Patent Application Publication
(10) Pub. No.: US 2007/0194471 A1
(43) Pub. Date: Aug. 23, 2007

(54) Reactor with packing mean

(76) Inventor: Tadayoshi Nagaoka, Osaka (JP)

Correspondence Address: James V Costigan;Hedman & Costigan, 1185 Avenue of the Americas, New York, NY, 10036-2646, US

(21) Appl. No.: 10/572,186

(22) PCT Filed: Sep. 17, 2003
(86) PCT No.: PCT/JP03/11799

§ 371 Date: Nov. 3, 2006

(51) Int. Cl. B01D 47/00

(52) U.S. Cl. 261/100

(57) ABSTRACT

There is provided a liquid-gas contact device which has a liquid distributor (2) provided in the upper portion of the device, a liquid collector (3) provided in the lower portion of the device and an internal structure between the liquid distributor (2) and the liquid collector (3) which defines a plurality of flow paths. The liquid-gas-contact device includes a column packing (5) constituting the internal structure made of a plurality of column packing constituting elements (6) each of which extends vertically in parallel to each other in a non-contact state and in a non-contact state with an inner wall of the device, a plurality of adaptors (4) connecting the liquid distributor (2) with the column packing (5) for supplying liquid from the liquid distributor (2) to the column packing (5), and a plurality of collectors (7) connecting the column packing (5) with the liquid collector (3) for supplying liquid from the column packing (5) to the liquid collector (3).

### TECHNICAL FIELD

This invention relates to a liquid-gas contact device for a device which, for performing material transfer, heat exchange or mixing between gases, liquids or gas and liquid, has a liquid distributor provided in the upper portion of the device, a liquid collector provided in the lower portion of the device and an internal structure between the liquid distributor and the liquid collector which defines a plurality of flow path.

### BACKGROUND ART

Known in the art of the liquid-gas contact device of this type is a column packing shown in the partial sectional view of FIG. 23. This column packing a is provided below a liquid distributor in a column and is made of a plurality of corrugated porous sheets laid in layers. These sheets b extend obliquely and are folded at a point at which they contact the inner wall c of the column and extend obliquely again. Liquid which has fallen as droplets from the liquid distributor flows down along these sheets b and wets the surfaces of the sheets b. On the other hand, gas enters from a gas inlet provided in the lower portion of the column, rises through the column packing a and exits out of the column through a gas outlet provided in the upper portion of the column. Liquid-gas contact is performed during passage of the gas through the column packing a and desired material transfer, heat exchange etc. thereby can be achieved.

The first problem of the prior art column pa-king is that the sheets b constituting the column packing a contact the inner wall c of the column at their folded edges. The liquid flowing along these sheets b is transferred to the inner wall c and a major portion of the transferred liquid flows down along the inner wall c without returning to the sheets b. On the other hand, the gas rising through the column packing of the prior art device has a parabolic flow velocity distribution in the radial direction of the cross-section of the gas flow, i.e., the flow velocity is the highest in the central portion of the gas flow and approaches nearly zero toward the inner wall due to viscosity. For this reason, the rising gas tends to flow in the central portion of the column and the gas hardly flows in the portion facing the inner wall of the column. By reason of this drift in the gas flow, the liquid flowing along the inner wall has much less contact with the gas than the liquid flowing in the central portion of the column. Thus, the liquid-gas contact is not performed uniformly and, therefore, chemical reaction to be achieved by the liquid-gas contact is not performed uniformly.

The second problem of the prior art column packing is that, in this column packing a, the oblique disposition of the sheets b causes a large pressure loss which results in a high energy consumption and a low efficiency.

The third problem of the prior art column packing is that increase in the load amount of gas makes a sound operation of the device difficult and, therefore, the upper limit of the load amount of gas has to be held at a relatively low level.

More specifically, when the flow amount of liquid supplied from the liquid distributor to the column is increased, the descending liquid spreads over the surface of the column packing a and wets the surface thereof. As the flow amount is increased further, the film of liquid on the surface of the column packing a becomes thick and a part of the liquid film is separated from the liquid film as a drop of the liquid. Thus, as the flow amount of gas supplied from the lower portion of the column increases while the liquid is flowing down, the liquid film tends to become droplets due to the high flow velocity of the gas and these droplets are blown upward by the rising gas. This causes reverse flow of the liquid which should flow down with resulting deterioration in the efficiency of reaction. This phenomenon of blowing between of droplets of the liquid by the rising gas is often seen in the space of the column between the liquid distributor and the top of the column packing and also in the space in the vicinity of the liquid collector provided in the lower portion of the column. Since the liquid distributor is expected to supply the liquid uniformly in the horizontal plane of the column packing, such phenomenon of blowing away of the liquid as droplets must be avoided as reducing the efficiency of the device. On the other hand, the liquid collector must collect the liquid without blowing away of the liquid as droplets. The prior art device has no effective means for preventing such blowing away of liquid droplets in the spaces between the liquid distributor and the column packing and in the space in the vicinity of the liquid collector.

For coping with the third problem of the prior art column packing, there has been proposed a liquid distribution collection device as disclosed in Japanese Patent Application Laid-open Publication No. 2001-170475. In this device, as shown in FIG. 24, a column d contains a liquid distributor e to which liquid distribution pipes f are attached. To nozzles g of the liquid distribution pipes f are connected liquid supply ropes h each of which is formed by twining strand sections m and the liquid supply ropes h are connected to a column packing i. Liquid is supplied from the liquid supply pipes f to the column packing i through the liquid supply ropes h and the strand section m branching from the liquid supply ropes h. The liquid which has completed liquid-gas contact is transferred to a liquid outlet 1 by means of a liquid collector k consisting of liquid collection ropes j which are formed by twining strand sections n. In this device, therefore, it is expected that the liquid is transferred accurately to the column packing and is collected from the column packing without being blown away even when the flow velocity of gas is high.

This liquid distribution and collection device theoretically seems to be an ideal device which has overcome the third problem of the prior art liquid-gas contact device. As a result of experiments, however, it has been found that even if the two strand sections m which constitute each liquid supply pipe h are made of the same number of wires, initial flow of the liquid on each of these wires does not necessarily become uniform due to a slight difference in the twisting angle between the wires and difference in affinity of the liquid to the surface of the wires but a flow path is formed in one of the wires which is the easiest wire for the liquid to flow before a flow path is formed in the other wires and the succeeding liquid tends to flow through this initially formed flow path, evading the other wires. Therefore, the liquid supplied from the liquid distributor to the liquid supply ropes h does not necessarily flow uniformly to the two strand sections m branching from these liquid supply ropes h and, as a result, the liquid does not flow uniformly to the column packing i and a perfect liquid-gas contact cannot be achieved.

It is, therefore, an object of the present invention to provide a liquid-gas contact device for a device performing material transfer etc. which does not cause lack of uniformity in the liquid-gas contact in the column packing due to the flow on the inner wall, which has improved pressure loss in the column, and removed blowing away of droplets of liquid due to increase in the flow velocity of gas in the space between the liquid distributor and the column packing and in the space in the vicinity of the liquid collector.

### DESCRIPTION OF THE INVENTION

For achieving the above described object of the invention, there is provided a liquid-gas contact device for a device which, for performing material transfer, heat exchange or mixing between gases, liquids or gas and liquid, has a liquid distributor provided in the upper portion of the device, a liquid collector provided in the lower portion of the device and an internal structure between the liquid distributor and the liquid collector which defines a plurality of flow paths, said liquid-gas-contact device comprising:

a column packing constituting the internal structure made of a plurality of column packing constituting elements each of which extends vertically in parallel to each other in a non-contact state and in a non-contact state with an inner wall of the device;

a plurality of adaptors connecting the liquid distributor with the column packing for supplying liquid from the liquid distributor to the column packing; and

a plurality of collectors connecting the column packing with the liquid collector for supplying liquid from the column packing to the liquid collector.

According to the invention, each column packing constituting element extends vertically in parallel to each other in a non-contact state and in a non-contact state with an inner wall of the device and, therefore, the liquid flowing down from the liquid distributor to each column packing constituting element flows to the liquid collector without being transferred to the surface of the inner wall or to an adjacent column packing constituting element to produce a drift. As a result, the amount of the liquid which flows on each column packing constituting element becomes uniform and a substantially uniform liquid-gas contact can be achieved. Further, since the liquid distributor and the column packing are connected directly by the adaptors and the column packing and the liquid collector are also connected directly by the collectors, scattering and blowing away of droplets of the liquid due to increase in the flow velocity of the gas in the space between the liquid distributor and the column packing and in the space between the column packing and the liquid collector can be effectively prevented.

In one aspect of the invention, each of the column packing constituting elements has a shape of a line or a belt and each of the adaptors is formed integrally with one of the column packing constituting elements and is connected directly to the liquid distributor without branching off from another adaptor and without causing another adaptor to branch off from the adaptor.

According to this aspect of the invention, since the adaptors are formed integrally with the column packing constituting elements, manufacture and installation of the adaptors are easy. Further, since the adaptors are connected to the liquid distributor without branching off from another adaptor and without causing another adaptor to branch off from the adaptor, there is no likelihood of occurrence of lack of uniformity due to branching of one adaptor from another and, as a result, the liquid is distributed uniformly to each column packing constituting-element.

In another aspect of the invention, said liquid distributor is made in the form a trough, each of the column packing constituting element is made in the form of a sheet and each of the adaptors is formed integrally with one of the column packing constituting elements and is connected directly to the liquid distributor without branching off from another adaptor and without causing another adaptor to branch off from the adaptor.

According to this aspect of the invention, since the adaptors are formed integrally with the column packing constituting elements, manufacture and installation of the adaptors are easy. Further, since the adaptors are connected to the liquid distributor without branching off from another adaptor and without causing another adaptor to branch off from the adaptor, there is no likelihood of occurrence of lack of uniformity due to branching of one adaptor from another and, as a result, the liquid is distributed uniformly to each column packing constituting element.

In another aspect of the invention, said liquid distributor is made in the form of a tube and each of the column packing constituting element is made in the form of a sheet and is cut vertically into a plurality of portions in the upper end portion thereof to form adaptors, said adaptors being held together in the tubular liquid distributor.

According to this aspect of the invention, in case the column packing constituting element is made in the form of a sheet, the column packing constituting element can be connected directly to the tubular liquid distributor without using a particular adaptor and, therefore, manufacture and installation of the adaptors are easy.

In another aspect of the invention, the liquid-gas contact device further comprises spacers made of elongated members provided and extending in a horizontal plane at a predetermined interval in a manner to cross the column packing constituting elements, said spacers being fixed to the column packing constituting elements at crossing points with the column packing constituting elements thereby maintaining a predetermined interval between the respective adjacent column packing constituting elements.

According to this aspect of the invention, since the respective column packing constituting elements are fixed to the spacers at the crossing points with the spacers, a predetermined interval can be maintained between the adjacent column packing constituting elements whereby an unequal flow of the liquid due to contact with the adjacent column packing constituting element can be prevented.

In another aspect of the invention, each of the column packing constituting element is made of a flat plate and a corrugated plate superposed one upon the other, said corrugated plate functioning as a spacer for maintaining a predetermined interval between the respective adjacent column packing constituting elements.

According to this aspect of the invention, the corrugated plate functions as a spacer for maintaining a predetermined interval between the adjacent column packing constituting element and, therefore, no particular spacer needs to be provided and installation of the device becomes easy.

In another aspect of the invention, each of the column packing constituting elements is made of a flat plate and a plurality of plates each having an arcuate cross section, said flat plate and arcuate plates being weaved integrally together and said arcualte plates functioning as spacers for maintaining a predetermined interval between the respective adjacent column packing constituting elements.

According to this aspect of the invention, the arcuate plates function as a spacer for maintaining a predetermined interval between the adjacent column packing constituting element and, therefore, no particular spacer needs to be provided and installation of the device becomes easy.

In another aspect of the invention, each of the column packing constituting elements is made of a zigzag line.

According to this aspect of the invention, time during which the liquid flows down along the column packing constituting element is prolonged and, therefore, time during which liquid-gas contact is made is also prolonged with the result that sufficient time for the reaction can be secured.

In another aspect of the invention, each of the column packing constituting elements is made of a spiral line.

According to this aspect also, time during which the liquid flows down along the column packing constituting element is prolonged and, therefore, time during which liquid-gas contact is made is also prolonged with the result that sufficient time for the reaction can be secured.

In another aspect of the invention, each of the column packing constituting elements is made of a zigzag-shaped belt.

In another aspect of the invention, each of the column packing constituting elements is made of a spiral belt.

In another aspect of the invention, there is provided, in a device which, for performing material transfer, heat exchange or mixing between gases, liquids or gas and liquid, has a liquid distributor provided in the upper portion of the device, a liquid collector provided in the lower portion of the device and a column packing between the liquid distributor and the liquid collector which defines a plurality of flow paths, adaptors for connecting the liquid distributor to the column packing for supplying liquid from the liquid distributor to the column packing, each of said adaptors being connected directly to the liquid distributor independently from the other adaptros without branching off from another adaptor and without causing another adaptor to branch off from said adaptor.

According to this aspect of the invention, since each of the adaptors is connected directly to the liquid distributor independently from the other adaptors without branching off from another adaptor and without causing another adaptor to branch off from said adaptor, there is no likelihood of unequal flow of the liquid due to branching of one adaptor from another and the liquid can be distributed uniformly form the liquid distributor to the column packing.

In another aspect of the invention, there is provided, in a device for a device which, for performing material transfer, heat exchange or mixing between gases, liquids or gas and liquid, has a liquid distributor provided in the upper portion of the device, a liquid collector provided in the lower portion of the device and an internal structure between the liquid distributor and the liquid collector which defines a plurality of flow paths, a column packing constituting the internal structure made of a plurality of column packing constituting elements each of which extends vertically in parallel to each other in a non-contact state and in a non-contact state with an inner wall of the device.

According to this aspect of the invention, in a case where the prior art column packing is replaced by the column packing of this aspect of the invention while a conventional liquid distributor is used, since each of the column packing constituting elements extends vertically in parallel to each other in a non-contact state and in a non-contact state with an inner wall of the device, a drift caused by the contact of the column packing constituting elements with the inner wall of the device can be eliminated and a uniform flow of the liquid can thereby be realized.

### BRIEF DESCRIPTION OF THE DRAWINGS

In the accompanying drawings,

FIG. 1 is a vertical sectional view showing an entire device in which the liquid-gas contact device of the present invention is schematically shown;

FIG. 2 is a perspective view of an embodiment of the liquid-gas contact device of the invention;

FIG. 3 is a cross sectional view of a column packing constituting element assembly of the embodiment;

FIG. 4 is a cross sectional view of a tubular liquid distributor with adaptors being inserted;

FIG. 5 is a perspective view showing a liquid distributor made in the form of a trough;

FIG. 6 is a perspective view showing another embodiment of the invention;

FIG. 7 is a cross sectional view of a column packing constituting element assembly of this embodiment;

FIG. 8 is a cross sectional view of a tubular liquid distributor with adaptors being inserted;

FIG. 9 is a perspective view showing another embodiment of the invention;

FIG. 10 is a cross sectional view of a column packing constituting element assembly of this embodiment;

FIG. 11 is a view showing a column packing constituting element in the form of a zigzag line;

FIG. 12 is a perspective view showing another embodiment of the invention;

FIG. 13 is a cross sectional view of a column packing constituting element assembly of this embodiment;

FIG. 14 is a perspective view showing another embodiment of the invention;

FIG. 15 is a cross sectional view of a column packing constituting element assembly of this embodiment;

FIG. 16 is a perspective view showing another embodiment of the invention;

FIG. 17 is a cross sectional view of a column packing of this embodiment;

FIG. 18 is a perspective view showing another embodiment of the invention;

FIG. 19 is a cross sectional view of a column packing of this embodiment;

FIG. 20 is a perspective view showing another embodiment of the invention;

FIG. 21 is a cross sectional view of a column packing of this embodiment;

FIG. 22 is a front view showing another embodiment of the invention;

FIG. 23 is a partial sectional view showing an example of the prior art liquid-gas contact device; and

FIG. 24 is a vertical sectional view showing another example of the prior art liquid-gas contact device.

### BEST MODE FOR CARRYING OUT THE INVENTION

Referring now to the accompanying drawings, preferred embodiments of the invention will be described.

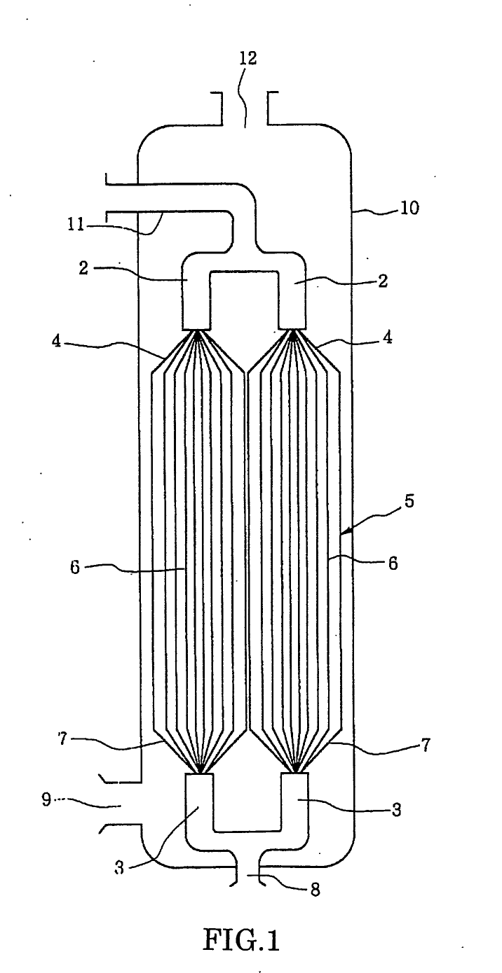

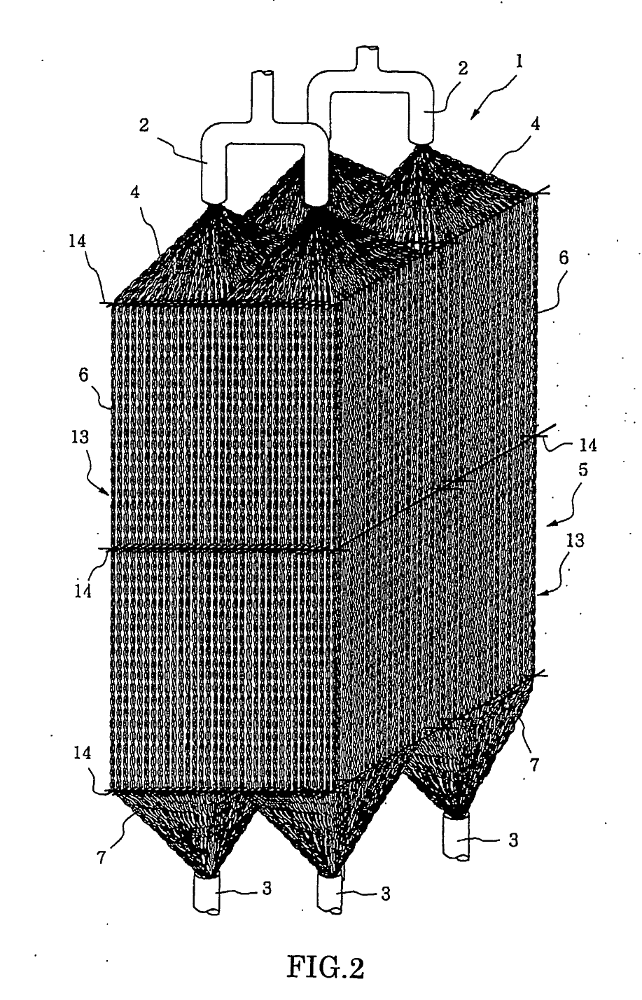

FIG. 1 and FIG. 2 show an embodiment of a liquid-gas contact device 1 in which FIG. 1 is schematic vertical sectional view and FIG. 2 is a perspective view showing the liquid-gas contact device 1.

In FIG. 1, a container 10 containing a column packing for performing liquid-gas contact for transfer of material between the liquid and gas or other function is a cylindrical column extending in the vertical direction. In the upper portion of the container 10 are provided a plurality of vertically extending, tubular liquid distributors 2 for distributing liquid which is the object of liquid-gas contact to the column packing provided below. The liquid is supplied from a liquid supply tube 11 to the liquid distributors 2. In the lower portion of the container 10 are provided a plurality of tubular liquid collectors 3 for collecting the liquid which has completed liquid-gas contact. The liquid collectors communicate with a liquid outlet 8.

In the lower portion of the side wall of the container 10 is provided a gas inlet 9 for introducing gas which is the object of liquid-gas contact and in the top of the container 10 is provided a gas outlet 12 for the gas which has completed the liquid-gas contact.

In the container 10 are disposed, from the top, adaptors 4 consisting of lines and connected to the liquid distributors 2, a column packing 5 consisting of column packing constituting elements 6 made of lines and formed integrally with the adaptors 4, and collectors 7 made of lines and formed integrally with the column packing constituting elements 6.

In this embodiment, as shown in FIG. 2, the liquid-gas contact device 1 comprises 4 vertically oblong box-like column packing constituting element assemblies 13, adaptors 4 and collectors 7. Each liquid distributor 2 supplies liquid to corresponding ones of the assemblies 13.

In the upper, middle and lower portions of each column packing constituting element assembly 13, each column packing constituting element 6 in the form of a line element extends vertically in parallel to each other in a non-contact state, i.e., maintaining a predetermined interval with each other in such a manner that the column packing constituting elements 6 form lines and columns in a horizontal section. Each column packing constituting element 6 is disposed in a manner to maintain a non-contact state with the inner wall of the container 10.

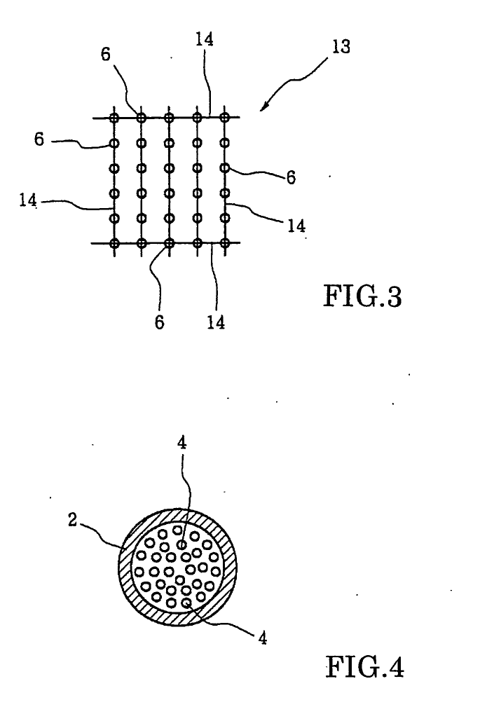

As shown in the cross-sectional view of FIG. 3, spacers 14 made of elongated members such as steel bars are provided in such a manner that each of the spacers 14 extends in a horizontal plane and crosses the column packing constituting elements 6 of each column of the column packing constituting element assembly 13. The spacers 14 are also provided in a manner to extend in a horizontal plane and cross the column packing constituting elements 6 of lines at the two ends of the column packing constituting element assembly 13. The spacers 14 may be provided in a manner to cross the column packing constituting elements 6 of all lines. Each spacer 14 is fixed at its two ends to the wall of the container or an unillustrated frame and is fixed to the column packing constituting elements 6 at each crossing point therewith by means of suitable means such as welding and bonding. The spacers 14 function to maintain a predetermined interval between the respective adjacent column packing constituting elements 6 and thereby prevent occurrence of a drift or deviation in the flow of the liquid due to shifting of the liquid between the respective adjacent constitutional elements.

In the present embodiment, each adaptor 4 consisting of a line element and connecting the liquid distributor 2 with the column packing 5 for supplying raw water from the liquid distributor 2 to the column packing 5 is formed integrally with one of the column packing constituting element 6 in one-to-one relation. Therefore, for each of the column packing constituting element assembly 13, the same number of adaptors 4 as the column packing constituting elements 6 constituting the column packing constituting element assembly 13 are provided. Each adaptor 4 is connected directly to the liquid distributor corresponding to each column packing constituting element assembly 13 without branching off from another adaptor and without causing another adaptor to branch off from the adaptor. Accordingly, a plurality of adaptors 4 which are integrally formed with column packing constituting elements 6 of one column packing constituting element assembly 13 are inserted and held in a bundle in the lower end portion of the tubular liquid distributor 2 corresponding to the assembly 13. FIG. 4 is a cross-sectional view showing the state of the lower end portion of the liquid distributor 2 in which the adaptors 4 are inserted in a bundle. The adaptors 4 are inserted somewhat loosely in the liquid distributor 2 in such a manner that a slight gap is formed between adjacent adaptors so that liquid flows down along the entire peripheral surface of each adaptor 4.

In the present embodiment, each collector 7 consisting of a line element and connecting a tubular liquid collector 3 with the column packing 5 for supplying liquid from the column packing 5 to the liquid collector 3 is formed integrally with one of the column packing constituting element 6 in one-to-one relation. Therefore, for each of the column packing constituting element assembly 13, the same number of collectors 7 as the column packing constituting elements 6 constituting the column packing constituting element assembly 13 are provided. Each collector 7 is connected directly to the liquid collector corresponding to each column packing constituting element assembly 13 without branching off from another collector and without causing another collector to branch off from the collector. Accordingly, a plurality of collectors 7 which are integrally formed with column packing constituting elements 6 of one column packing constituting element assembly 13 are inserted and held in a bundle in the upper end portion of the tubular liquid collector 3 corresponding to the assembly 13.

As the line elements used for forming the column packing constituting elements 6, adaptors 4 and collectors 7, a metal line or any type of fiber including plastic fiber, carbon fiber, ceramic fiber, plant fiber such as cotton fiber and animal fiber such as wool may be used. The line element may be made of a monofilament or a single piece of wire but a line element made of twine which is made by twisting thin steel lines or plastic lines is preferable because liquid flows along the space between the lines which constitute the wire or twine due to the capillary action and thereby enhances transfer of the liquid. In the present embodiment, seven steel lines each having a diameter of 0.1 mm are twisted together to a single wire and two of these wires are twisted together to a single wire and this wire is used as the column packing constituting element 6, the adaptor 4 and the collector 7.

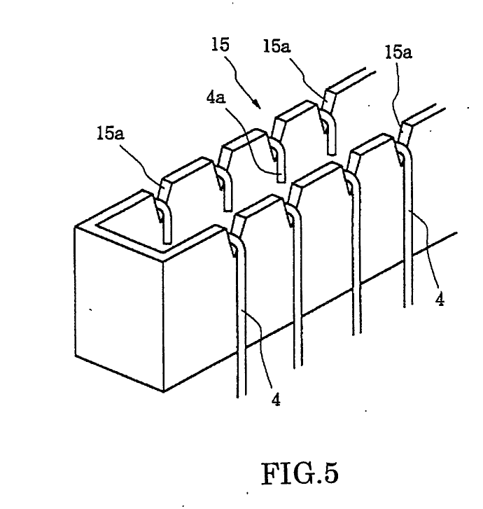

As the liquid distributor, a tubular liquid distributor 2 as shown in FIGS. 1 and 2 may be used. Alternatively, a liquid distributor 15 as shown in FIG. 5 which is made in the form of a trough may be used. This liquid distributor 15 is formed with notches 15a on both sides thereof which constitute liquid outlets. Each adaptor 4 made in the form of a line element is connected to the liquid distributor 15 by hanging the folded upper end portion of the adaptor 4 on the notch 15a.

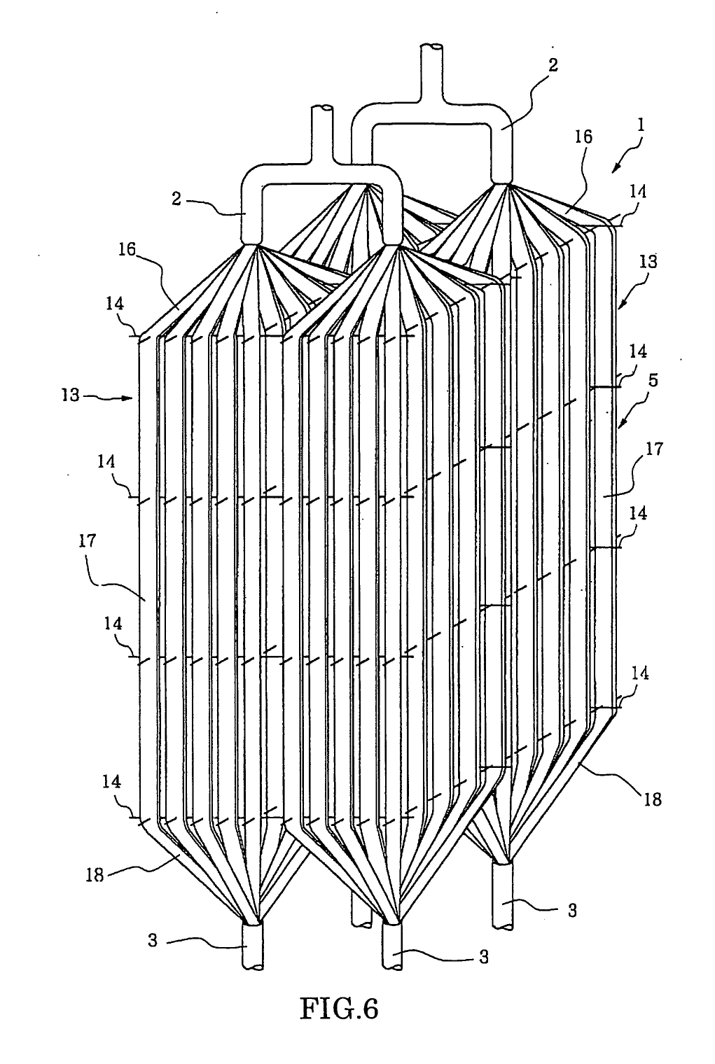

FIG. 6 shows another embodiment of the invention. In this and subsequent embodiments, the same component parts as those in the embodiment of FIGS. 1 and 2 are shown by the same reference characters and description thereof will be omitted.

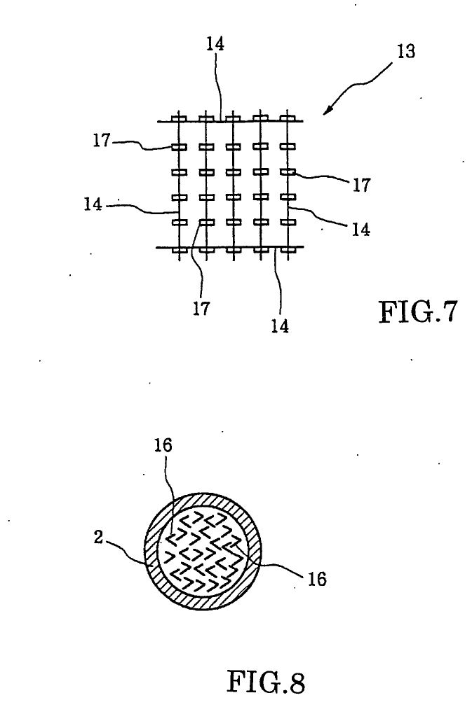

This embodiment differs from the embodiment of FIG. 1 in that an adaptor 16, a column packing constituting element 17 constituting a column packing 5 and a collector 18 are integrally formed with a single belt. The belt may be made, for example, by a woven fabric made of steel wires. A cross section of each column packing constituting element assembly 13 is shown in FIG. 7.

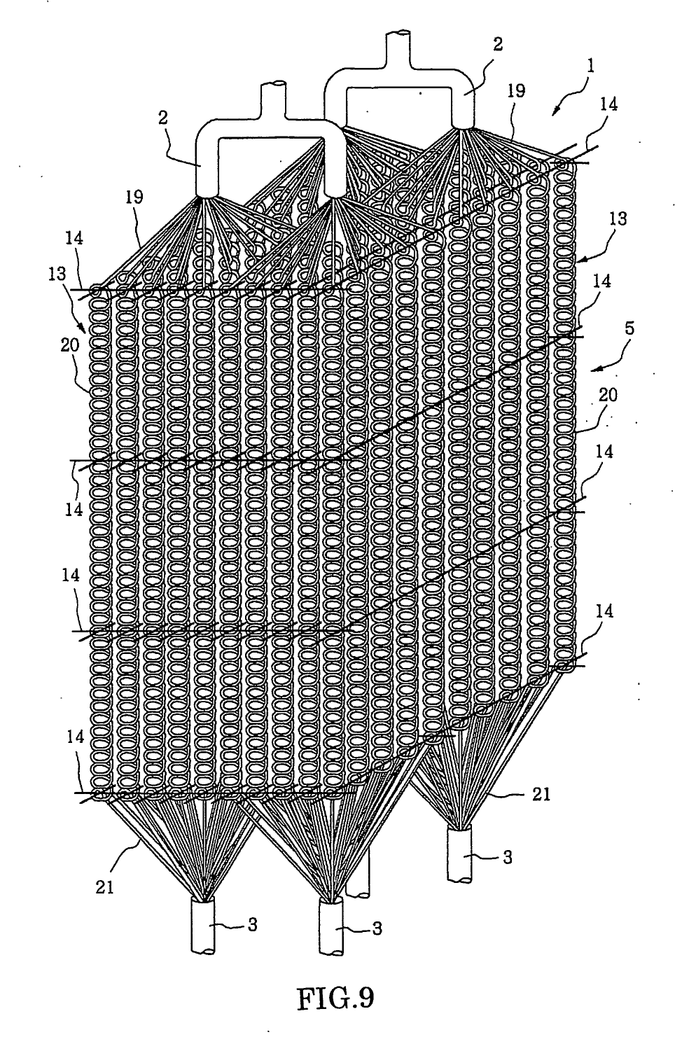

A cross section of the lower end portion of the tubular liquid distributor 2 in which the adaptors 16 in the form of belts are collectively inserted is shown in FIG. 8. The adaptors 16 each of which is folded into two parts are randomly inserted in the tubular liquid distributor 2 in a loose bundle so that the liquid will flow down along the entire periphery of each adaptor 16.

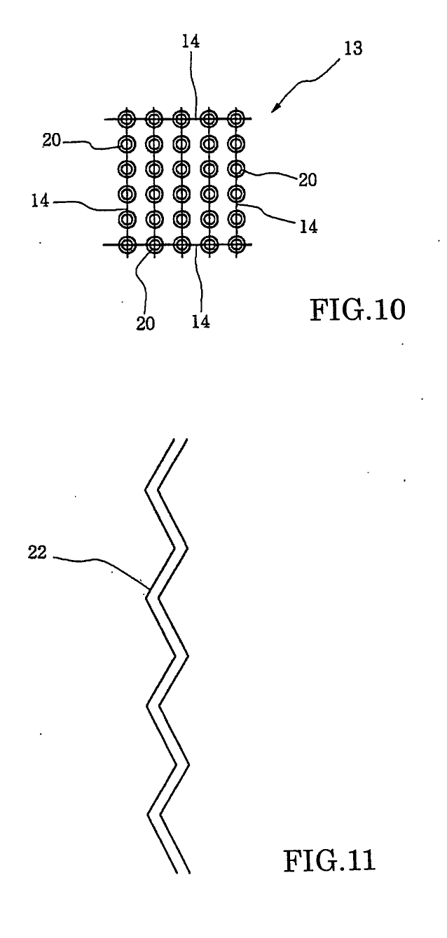

FIG. 9 shows another embodiment of the invention. This embodiment is similar to the embodiment of FIG. 1 in that an adaptor 19, a column packing constituting element 20 constituting a column packing 5 and a collector 21 are integrally formed by a single line element but each column packing constituting element 20 is made of a spiral line. By this arrangement, time during which the liquid flows down along the column packing constituting elements 20 is prolonged and time during which the liquid-gas contact is made thereby is prolonged. A cross section of each column packing constituting element assembly 13 is shown in FIG. 10.

For the same purpose, a column packing constituting element 22 as shown in FIG. 11 in the form of a zigzag line may be used.

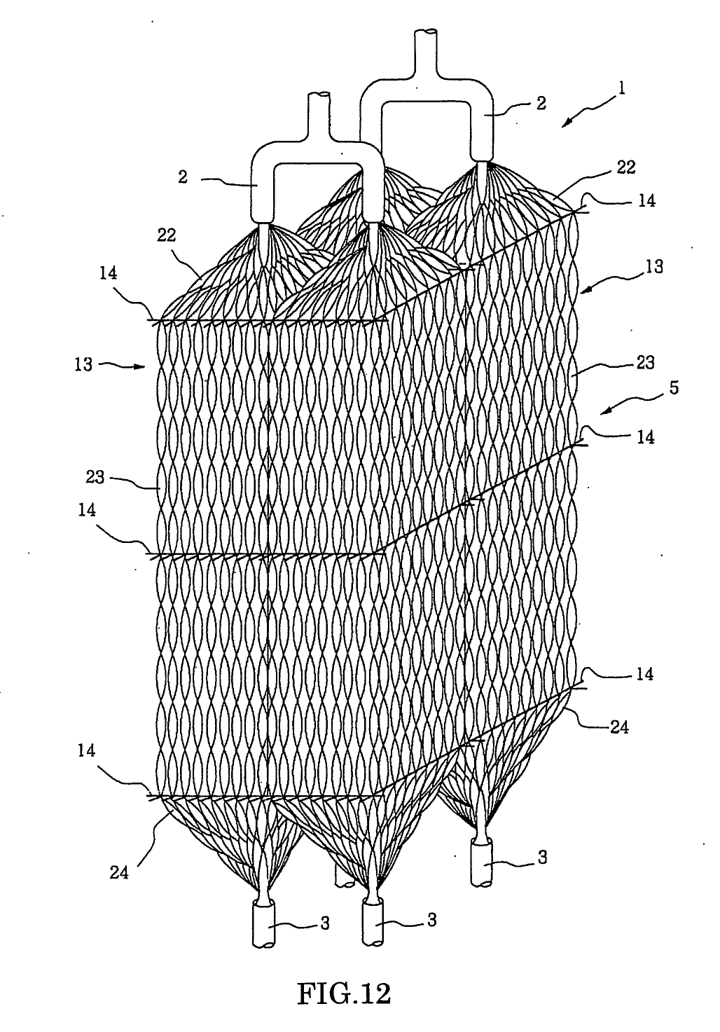

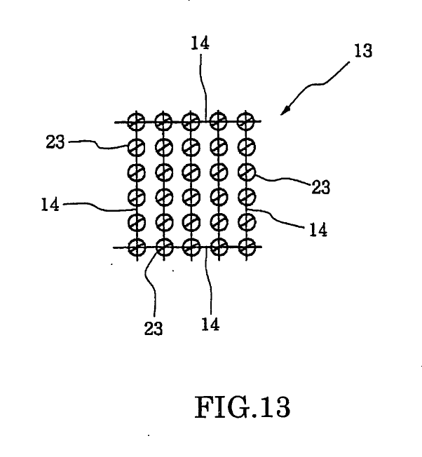

FIG. 12 shows another embodiment of the invention. This embodiment is similar to the embodiment of FIG. 6 in that an adaptor 22, a column packing constituting element 23 constituting a column packing 5 and a collector 24 are integrally formed with a single belt but each column packing constituting element 23 in the form of a belt is twisted continuously and gradually to form a spiral belt. By this arrangement, time during which the liquid flows down along the column packing constituting elements 23 is prolonged and time during which the liquid-gas contact is made thereby is prolonged. A cross section of each column packing constituting element assembly 13 is shown in FIG. 13.

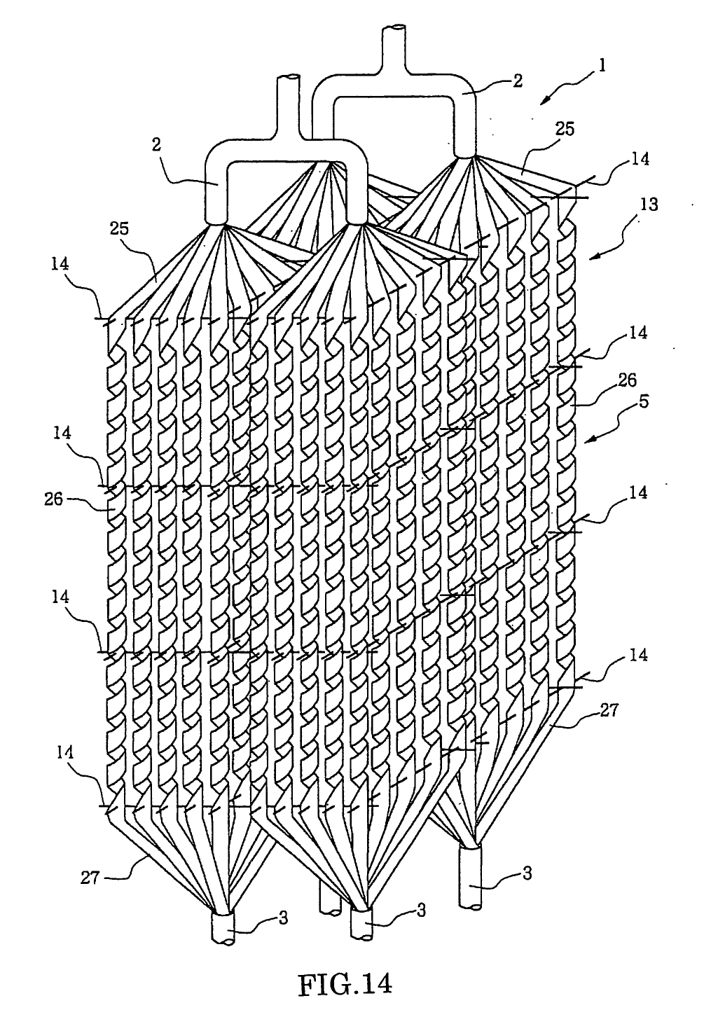

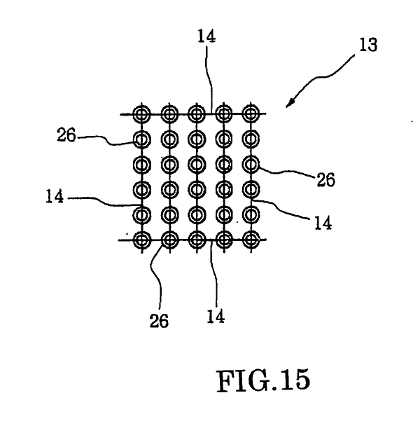

FIG. 14 shows another embodiment of the invention. This embodiment is similar to the embodiment of FIG. 6 in that an adaptor 25, a column packing constituting element 26 constituting a column packing 5 and a collector 27 are integrally formed with a single belt but each column packing constituting element 26 in the form of a belt is twisted continuously to form a spiral belt having a sharper spiral angle than the column packing constituting element 23 of FIG. 12. By this arrangement, time during which the liquid flows down along the column packing constituting elements 26 is prolonged and time during which the liquid-gas contact is made thereby is prolonged. A cross section of each column packing constituting element assembly 13 is shown in FIG. 15.

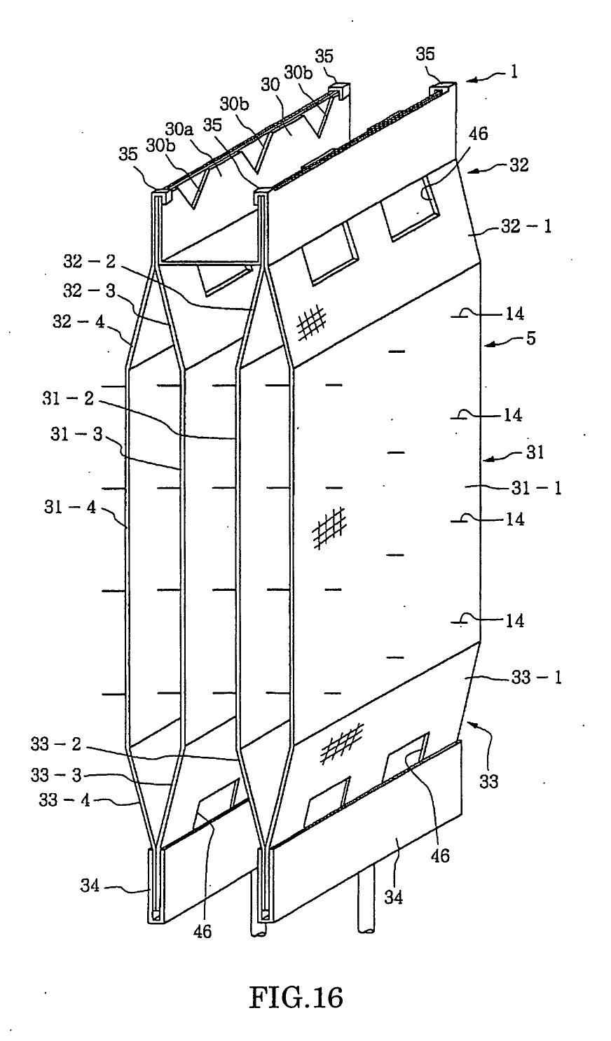

FIG. 16 shows another embodiment of the invention. In this embodiment, the liquid distributor is made of a trough 30. Each of a column packing constituting element 31, an adaptor 32 and a collector 33 is made in the form of a sheet consisting of a wire-mesh and these column packing constituting element 31, adaptor 32 and collector 33 are formed integrally to form a continuous sheet. The adaptor 32 is connected directly to the trough 30 without branching off from another adaptor and without causing another adaptor to branch off from it.

In the illustrated embodiment, a column packing constituting element 31-1, an adaptor 32-1 and a collector 33-1 are formed integrally to form a sheet and a column packing constituting element 31-2, an adaptor 32-2 and a collector 33-2 are formed integrally to form a sheet. These two sheets form a pair and the upper end portions of the adaptors 32-1 and 32-2 and the lower end portions of the collectors 33-1 and 33-2 are welded to each other. Likewise, a column packing constituting element 31-3, an adaptor 32-3 and a collector 33-3 are formed integrally to form a sheet and a column packing constituting element 31-4, an adaptor 32-4 and a collector 33-4 are formed integrally to form a sheet. These two sheets form a pair and the upper end portions of the adaptors 32-3 and 32-4 and the lower end portions of the collectors 33-3 and 33-4 are welded to each other.

The upper end portions of the adaptors 32-1 and 32-4 are bent inwardly in the form of a hook to form engaging portions 35 by means of which the respective sheets hang from side walls 30a of the trough 30.

The side walls 30a of the trough 30 are formed with liquid outlet notches 30b. The upper portions of the adaptors 32-1 to 32-4 and the lower portions of the collectors 33-1 to 33-4 are formed with gas inlets 46 for allowing flow of the gas.

The welded pair of the collectors 33-1 and 33-2 and the welded pair of the collectors 33-3 and 33-4 are respectively inserted in liquid collectors 34 which communicate with unillustrated liquid outlets.

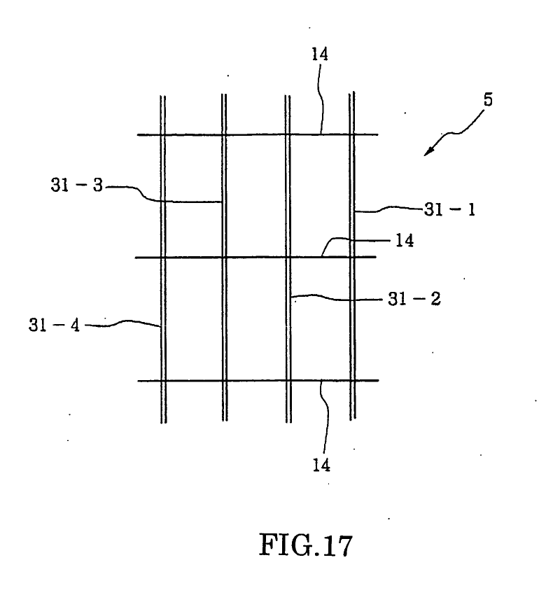

A cross section of this column packing 5 is shown in FIG. 17.

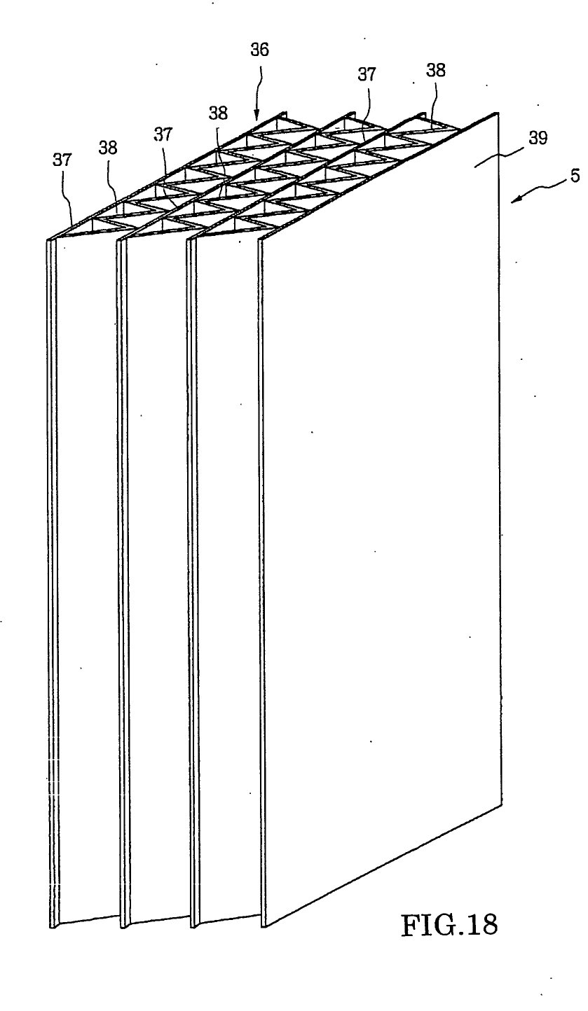

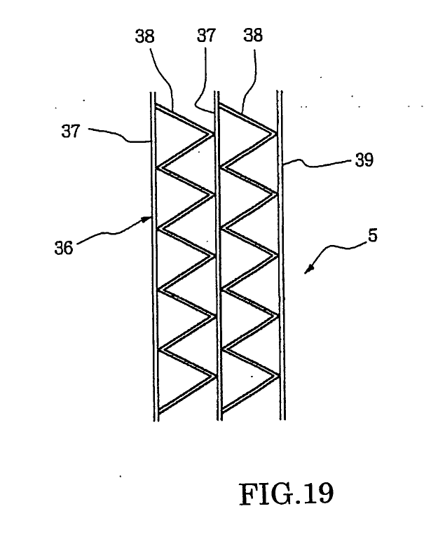

FIG. 18 shows another embodiment of the invention. In this embodiment, each column packing constituting element 36 constituting a column packing 5 is made of a sheet 37 consisting of a flat wire-mesh and a sheet 38 consisting of a corrugated wire-mesh superposed one upon the other. In this embodiment, the corrugated sheet 38 functions as a spacer for maintaining a predetermined interval between adjacent flat sheets 37 and, therefore, bar-like spacers 14 used in the respective embodiments described above are unnecessary and, as a result, installation of the column packing becomes easy. Across section of this embodiment is shown in FIG. 19.

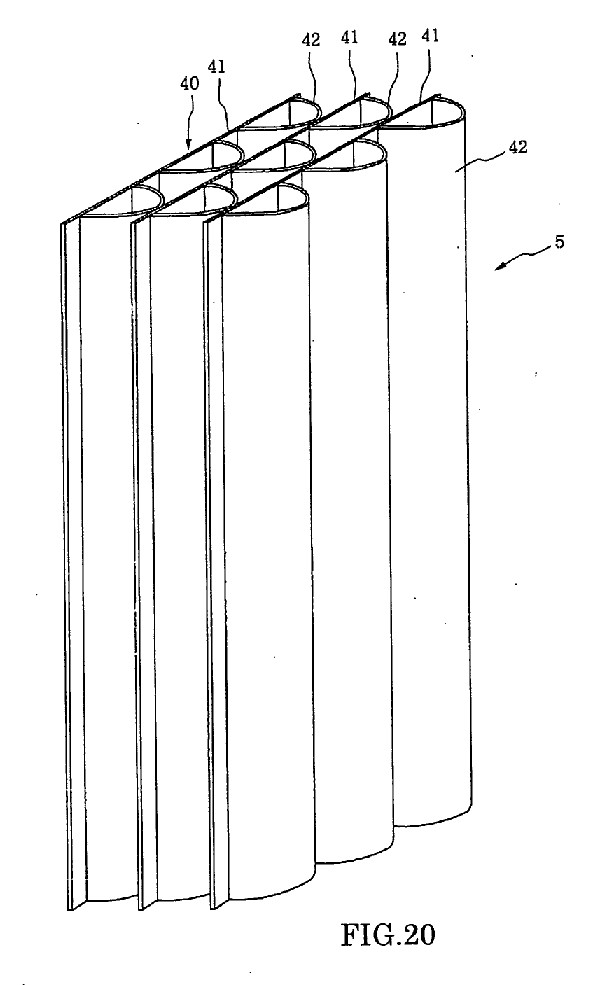

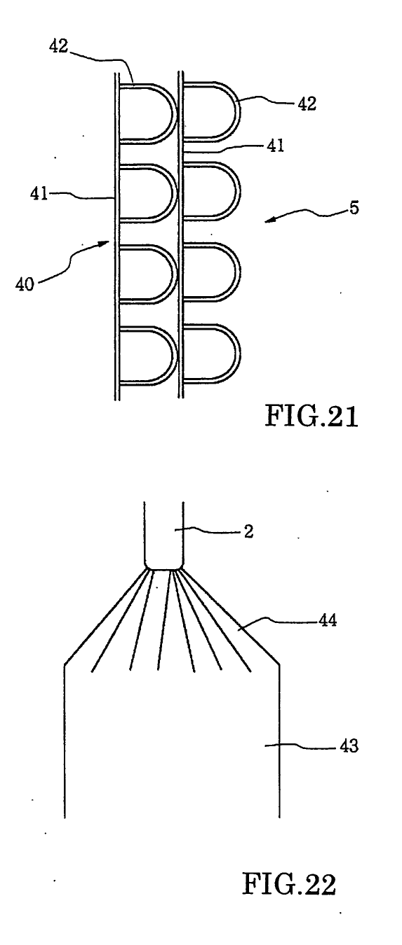

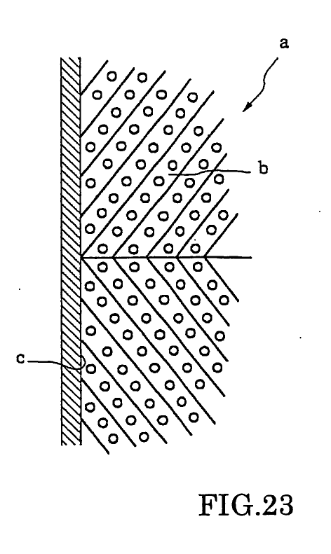

FIG. 20 shows another embodiment of the invention. In this embodiment, each column packing constituting element 40 constituting a column packing 5 is made of a sheet 41 consisting of a flat wire-mesh and a plurality of sheets 42 each having an arcuate cross section with the flat sheet 41 and the arcuate sheets 42 being weaved integrally together. In this embodiment, the arcuate sheets 42 function as spacers for maintaining a predetermined interval between adjacent flat sheets 41 and, therefore, bar-like spacers 14 used in the respective embodiments described above are unnecessary and, as a result, installation of the column packing becomes easy. A cross section of this embodiment is shown in FIG. 21.

FIG. 22 shows another embodiment of the invention. In this embodiment, a liquid distributor 2 is made in the form of a tube and a column packing constituting element 43 is made in the form of a sheet consisting of a wire-mesh and is cut vertically into a plurality of portions in the upper end portion thereof to form adaptors 44, these adaptors being held together in the tubular liquid distributor 2.

According to this aspect of the invention, in case the column packing constituting element 43 is made in the form of a sheet, the column packing constituting element 43 can be connected directly to the tubular liquid distributor 2 without using a particular adaptor and, therefore, manufacture and installation of the adaptors are easy.

In the above described embodiments, the adaptors are integrally formed with the column packing constituting elements. Alternatively, the adaptor and the column packing constituting element may be manufactured separately and may be joined together.

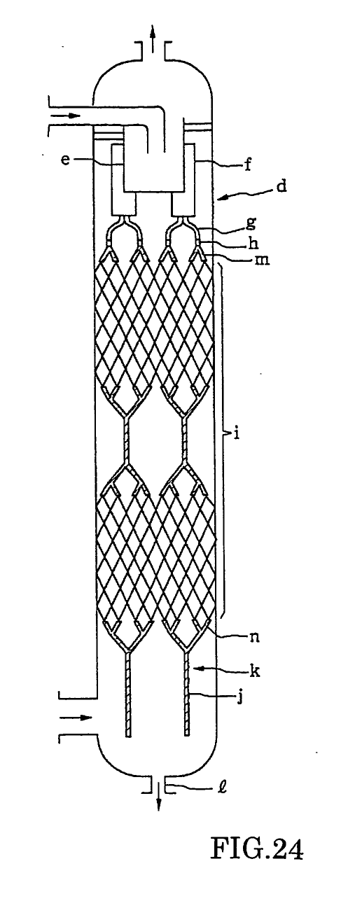

In a case where the adaptor of the present invention which is directly connected to the liquid distributor without branching off from another adaptor and without causing another adaptor to branch off from the adaptor is used for a column packing of the X-packing type of Japanese Patent Application Laid-open Publication No. 2001-170475 which is shown in FIG. 24, efficiency of liquid-gas contact is improved as compared with the case where the branching type adaptor of FIG. 24 is used.

### EXAMPLE

For confirming the effect of the adaptor of the present invention, the following experiment was made.

In a vacuum distillation tower, the X-packing shown in Japanese Patent Application Laid-open Publication No. 2001-170475 was filled as a column packing and this X-packing was connected to the liquid distributor provided in the upper portion of the tower by means of the line adaptors 4 shown in FIG. 4 of the present invention. Each adaptor 4 was made by twisting four steel lines each having a diameter of 0.25 mm together to form a single wire and twisting two of these wires together. By using this device, vacuum distillation was conducted with respect to a two-component system of chlorobenzene and ethylbenzene. More specifically, vapor of these two components was blown up from the lower portion of the tower and the vapor reaching the upper portion of the tower was condensed by a condenser. The liquid of the condensed components was distributed from the liquid distributor to the X-packing through the adaptors to effect the liquid-gas contact. The experiment was made by using a gas velocity of F factor 2. Results of the experiment show that the theoretical stage number Nt per 1 m which represents that the efficiency of the device was 7.6 and the surface area of the column packing required for obtaining 1 Nt was 65 m². Degree of concentration of the gas at the top of the tower was 77.5 weight %.

For comparison, an experiment was made under the same experimental conditions except that the branching type adaptors disclosed by Japanese Patent Application Laid-open Publication No. 2001-170475 was used instead of the above described adaptors 4 of FIG. 2 of the present invention. Each adaptor was made by twisting four steel lines each having a diameter of 0.25 mm together to form a single wire and twisting two of these wires together. Results of the experiment show that the theoretical stage number Nt per 1 m was 6.8 and the surface area of the column packing required for obtaining 1 Nt was 72 m². Degree of concentration of the gas at the top of the tower was 76.7 weight %.

From the results of the experiments, it was shown that, though the same column packing was used, use of the adaptors of the present invention decreased the surface area of the column packing required for obtaining 1 Nt from 72 m² to 65 m² and increased the degree of concentration from 76.7% to 77.5%, indicating that use of the adaptors of the present invention improved the efficiency of the liquid-gas contact device significantly.

Since the adaptors of the present invention can distribute liquid from the liquid distributor uniformly, they can improve the efficiency of the existing column packing when they are used for distributing liquid to the existing column packing.

As the collectors, the collectors disclosed by Japanese Patent Application Laid-open Publication No. 2001-170475 may be used instead of the collectors of the present invention.

If the collectors of the present invention are disposed below the existing column packing, liquid which has completed condensation, for example, can be collected by causing the liquid to flow along these collectors, and the drawback of the prior art device in which the liquid collected as droplets is blown up by the gas is eliminated whereby the efficiency of the device can be improved.

Use of the adaptors and collectors of the present invention above and below the existing column packing not only improves the efficiency of the existing column packing but also enables operation of the device under a higher load because free falling of droplets of liquid is prevented.

In case the existing column packing is replaced by the column packing of the present invention while the conventional liquid distributor is used, the column packing constituting elements of the present invention extend vertically in parallel in a non-contact state and in a non-contact state with the inner wall of the column and, therefore, the liquid flows in a uniform flow whereby separation efficiency of the device can be significantly improved.

Further, in case the height of the column is extremely restricted, the collectors of the present invention may be connected directly to the adaptors of the present invention. In other words, even in a case where there is no space for providing the existing column packing, a sufficient efficiency of liquid-gas contact can be achieved.

### INDUSTRIAL APPLICABILITY

The present invention can be applied to a liquid-gas contact device in a device for performing material transfer, heat exchange or mixing between gases, liquids or gas and liquid.

1. A liquid-gas contact device for a device which, for performing material transfer, heat exchange or mixing between gases, liquids or gas and liquid, has a liquid distributor provided in the upper portion of the device, a liquid collector provided in the lower portion of the device and an internal structure between the liquid distributor and the liquid collector which defines a plurality of flow paths, said liquid-gas-contact device comprising:
a column packing constituting the internal structure made of a plurality of column packing constituting elements each of which extends vertically in parallel to each other in a non-contact state and in a non-contact state with an inner wall of the device;
a plurality of adaptors connecting the liquid distributor with the column packing for supplying liquid from the liquid distributor to the column packing; and
a plurality of collectors connecting the column packing with the liquid collector for supplying liquid from the column packing to the liquid collector.

2. A liquid-gas contact device as defined in claim 1 wherein each of the column packing constituting elements has a shape of a line or a belt and each of the adaptors is formed integrally with one of the column packing constituting elements and is connected directly to the liquid distributor without branching off from another adaptor and without causing another adaptor to branch off from the adaptor.

3. A liquid-gas contact device as defined in claim 1 wherein said liquid distributor is made in the form a trough, each of the column packing constituting element is made in the form of a sheet and each of the adaptors is formed integrally with one of the column packing constituting elements and is connected directly to the liquid distributor without branching off from another adaptor and without causing another adaptor to branch off from the adaptor.

4. A liquid-gas contact device as defined in claim 1 wherein said liquid distributor is made in the form of a tube and each of the column packing constituting element is made in the form of a sheet and is cut vertically into a plurality of portions in the upper end portion thereof to form adaptors, said adaptors being held together in the tubular liquid distributor.

5. A liquid-gas contact device as defined in claim 2 further comprising spacers made of elongated members provided and extending in a horizontal plane at a predetermined interval in a manner to cross the column packing constituting elements, said spacers being fixed to the column packing constituting elements at crossing points with the column packing constituting elements thereby maintaining a predetermined interval between the respective adjacent column packing constituting elements.

6. A liquid-gas contact device as defined in claim 1 wherein each of the column packing constituting element is made of a flat plate and a corrugated plate superposed one upon the other, said corrugated plate functioning as a spacer for maintaining a predetermined interval between the respective adjacent column packing constituting elements.

7. A liquid-gas contact device as defined in claim 1 wherein each of the column packing constituting elements is made of a flat plate and a plurality of plates each having an arcuate cross section, said flat plate and arcuate plates being weaved integrally together and said arcuate plates functioning as spacers for maintaining a predetermined interval between the respective adjacent column packing constituting elements.

8. A liquid-gas contact device as defined in claim 2 wherein each of the column packing constituting elements is made of a zigzag line.

9. A liquid-gas contact device as defined in claim 2 wherein each of the column packing constituting elements is made of a spiral line.

10. A liquid-gas contact device as defined in claim 2 wherein each of the column packing constituting elements is made of a zigzag-shaped belt.

11. A liquid-gas contact device as defined in claim 2 wherein each of the column packing constituting elements is made of a spiral belt.

12. In a device which, for performing material transfer, heat exchange or mixing between gases, liquids or gas and liquid, has a liquid distributor provided in the upper portion of the device, a liquid collector provided in the lower portion of the device and a column packing between the liquid distributor and the liquid collector which defines a plurality of flow paths, adaptors for connecting the liquid distributor to the column packing for supplying liquid from the liquid distributor to the column packing, each of said adaptors being connected directly to the liquid distributor independently from the other adaptors without branching off from another adaptor and without causing another adaptor to branch off from said adaptor.

13. In a device for a device which, for performing material transfer, heat exchange or mixing between gases, liquids or gas and liquid, has a liquid distributor provided in the upper portion of the device, a liquid collector provided in the lower portion of the device and an internal structure between the liquid distributor and the liquid collector which defines a plurality of flow paths, a column packing constituting the internal structure made of a plurality of column packing constituting elements each of which extends vertically in parallel to each other in a non-contact state and in a non-contact state with an inner wall of the device.
